(19) United States
(12) Patent Application Publication
(10) Pub. No.: US 2017/0176127 A1
(43) Pub. Date: Jun. 22, 2017

(54) SIMULATED FIREARMS ENTERTAINMENT SYSTEM

(71) Applicant: BOB FERRIS, MESA, AZ (US)

(72) Inventor: BOB FERRIS, MESA, AZ (US)

(21) Appl. No.: 15/452,689

(22) Filed: Mar. 7, 2017

Related U.S. Application Data
(63) Continuation-in-part of application No. 13/621,836, filed on Sep. 17, 2012, now Pat. No. 8,894,412.
Application No. 13/621,836 is a continuation-in-part of application No. 13/230,834, filed on Sep. 12, 2011, now Pat. No. 8,267,691.
Application No. 13/230,834 is a continuation-in-part of application No. 12/643,097, filed on Dec. 21, 2009, now Pat. No. 8,016,594.
Application No. 12/643,097 is a continuation of application No. 11/286,162, filed on Nov. 22, 2005, now abandoned.
(60) Provisional application No. 60/633,080, filed on Dec. 3, 2004.

(51) Int. Cl. F41A 33/00; A63F 13/537; A63F 13/837; A63F 13/35

(52) U.S. Cl. CPC F41A 33/00; A63F 13/35; A63F 13/537; A63F 13/837

(57) ABSTRACT

A firearm simulation system includes multiple game play and participation options for a plurality of users in an entertainment venue located outside of a home environment. The most preferred embodiments of the present invention include options for interaction between the users to create a social experience for friends, neighbors, co-workers, etc. to enjoy out-of-home firearms simulation entertainment, including options such as consuming food and drink, integrated leader boards, pictures and video of the participants, tweets, email notices, and other social media interaction. The most preferred embodiments of the present invention incorporate simulated firearms used in a casual, fun, and fast-paced entertainment venue to enhance the ease of use and the enjoyment of the experience for the participants.

### BACKGROUND OF THE INVENTION

1. Field of the Invention

The present invention relates generally to the field of firearms and more specifically relates to entertainment systems featuring simulated firearms.

2. Related Art

There are a wide variety of entertainment activities available in the world today. Many people enjoy the opportunity to relax with friends and families by visiting amusement parks, bowling alleys, fairs, etc. A subset of entertainment activities includes simulation devices that provide experiences such as flying a plane, driving a car, hunting, fishing, etc. With the increasing popularity of firearms use and training, firearms simulator devices have become more prevalent.

For example, there are amusement parks and other venues that feature arcade games that use plastic guns with no or minimal recoil effect. These firearms-related arcade games are usually focused on “first person” shooter scenarios and are not generally intended to provide a simulated shooting range environment or head-to-head competition using realistic firearms.

Similarly, a wide range of computer video games include a variety of skills tests or competition games. However, these video games systems are intended for “at home” usage and normally assume some type of keyboard and/or mouse input, do not use realistic firearms, and are not intended to simulate a shooting range experience. Many of these video game systems include plastic guns but the simulated weapons lack the realism and other features needed for more realistic entertainment at a venue away from the home environment.

There are also a number of professional firearm simulator systems available that are used primarily by military and law enforcement personnel for training purposes. These systems typically include some skill or competition games and offer a more realistic shooting range experience, and include realistic firearms. However, these systems are not available to the general public and are focused on serious firearms training and not entertainment.

Accordingly, without improvements to the current equipment, methods, and venues for providing firearms related entertainment, the overall potential of these systems will continue to be sub-optimal.

### BRIEF SUMMARY OF THE INVENTION

A firearm simulation system includes multiple game play and participation options for a plurality of users in an entertainment venue located outside of a home environment. The most preferred embodiments of the present invention include options for interaction between the users to create a social experience for friends, neighbors, co-workers, etc. to enjoy out-of-home firearms simulation entertainment, including options such as integrated leader boards, pictures and video of the participants, tweets, email notices, and other social media interaction. The most preferred embodiments of the present invention incorporate simulated firearms used in a casual, fun, and fast-paced entertainment venue to enhance the ease of use and the enjoyment of the experience for the participants.

### BRIEF DESCRIPTION OF THE SEVERAL VIEWS OF THE DRAWINGS

None.

### DETAILED DESCRIPTION OF THE INVENTION

A firearm simulation system includes multiple game play and participation options for a plurality of users in an entertainment venue located outside of a home environment. The most preferred embodiments of the present invention include options for interaction between the users to create a social experience for friends, neighbors, co-workers, etc. to enjoy out-of-home firearms simulation entertainment, including options such as integrated leader boards, pictures and video of the participants, tweets, email notices, and other social media interaction. The most preferred embodiments of the present invention incorporate simulated firearms used in a casual, fun, and fast-paced entertainment venue to enhance the ease of use and the enjoyment of the experience for the participants.

The most preferred embodiments of the present invention comprise a system with at least several of the following options:
one or more replica firearm (such as a pistol or rifle) that emits a laser when the shooter pulls the trigger coupled with laser detection capabilities to track a projected point of impact for the laser emitted by the simulated weapon;
one or more “shooting bays” which include a projector, computer, and sound system that are used to display games and or scenarios to the shooters;
one or more input devices so the shooter(s) can activate or deactivate a particular game
a method by which a user can “zero the weapon”, meaning the user can have a laser firing replica firearm adjusted so that when the user aims and fires the weapon correctly the impact is as expected;
a method by which a user can confirm the laser firing weapon is firing accurately;
a method to determine and present scores to the shooter (as well as others) based on: accuracy (e.g., based on how close to the bullseye the shots land), speed (how quickly did you aim and fire), shooting the right targets, not shooting the wrong targets, or a combination of the above.
   Additional capabilities:
In at least one preferred embodiment of the present invention, a webcam is added to the system so that video and/or still pictures could be captured and used in various activities (e.g., insertion into leader board, social media use, email messages, score surpassed alerts, associating a person's face with an user account, etc.).
In at least one preferred embodiment of the present invention, whenever a user has the bay active, the user has the option to take a screen shot of what is showing on the simulator screen and quickly (one button press) or automatically share it via standard communication and social media platforms (e.g., email, SMS, Twitter®, Instagram®, Facebook® post, etc.).
In at least one preferred embodiment of the present invention, the user can capture a picture or video image of themselves (and others) in the bay and share it via standard communication and social media platforms (e.g., email, SMS, Twitter®, Instagram®, Youtube®, Facebook® post, etc.). In addition, the shooter has the ability to combine multiple images in a manual or an automated generated “collage” fashion to display multiple images of the people and of the results (scores, or targets, etc.) in the same final image or post.
In at least one preferred embodiment of the present invention, when a user achieves a high score, the shooter will be prompted to stand in a pre-determined location within the bay and press a button to capture a picture of themselves. The picture is used as their image for the leader board and also sent out to other shooters on the leaderboard who have been displaced by the new high score.
In at least one preferred embodiment of the present invention, when a team achieves a high score, the team will be prompted to stand in a pre-determined location within the bay and press a button to capture a picture of themselves. The picture is used as their image for the leader board and also sent out to other shooters on the leaderboard who have been displaced by the new high score.
In at least one preferred embodiment of the present invention, team scores are more heavily weighted than individual scores.
In at least one preferred embodiment of the present invention, cooperative games and scenarios allow for more than one person to work together to succeed.
In at least one preferred embodiment of the present invention, every person in the bay plays at the same time in a full team game or scenario.
In at least one preferred embodiment of the present invention, bays could be interconnected so that more people could play the same game at the same time. This interconnection could occur both locally and remotely, using the internet to connect remote facilities with one another.
In at least one preferred embodiment of the present invention, the user (or a team) can select to do a “ranked” game or scenario in which their performance during the experience will influence how they rank when compared with other users. Otherwise the user (or a team) will be in “unranked” mode where they don't have the pressure of their performance influencing their ranking.
In at least one preferred embodiment of the present invention, a plurality of automated, user-selectable options are provided to automatically create a montage of multiple images (e.g., a webcam picture of the bay, a screen shot of a bullet cam, and a screen shot of the ranking, and the shooter's image). The shooter simply selects one of the pre-configured options and the automatically generated montage is transmitted to the customer's social media options. The montage creation is automatically generated by the system and is presented for the shooter to review and confirm prior to distribution.
In at least one preferred embodiment of the present invention, a computer implemented method is used to compare different scores between multiple geographic locations, maintain high scores for each game broken down for locations, male/female, regions, ages, leagues, corporations/groups, in a national and international competitive or cooperative scenario. For example, different sub-groups within a larger group (e.g., divisions within a corporation) could easily compare their individual or team scores on different games.
In at least one preferred embodiment of the present invention, a computer implemented method is provided to rank each shooter based on a plurality of criteria (e.g., age, accuracy, speed, frequency, etc.) and extra fees may be paid to increase ranking, however other methods exist to increase ranking, such as hours played, money spent over a period of time, or ranking high in one or more games (based on firearms skills).
In at least one preferred embodiment of the present invention, a shooter's virtual ranking might mirror a commonly used ranking system, such as lieutenant through 4-star General.
In at least one preferred embodiment of the present invention, the ranking of the highest ranked member of a group (e.g., league or team play) would be displayed at the top of the simulator screen and/or user input screen before, during, or after each game play session. This provides a way for other shooters in the league or team to see competitive ranking).
In at least one preferred embodiment of the present invention, a player can earn or be awarded additional privileges and game play options, based on achieving a certain score. This may include options such as higher priority for making reservations, less time waiting, early access to new games, the ability to use a design-your-own game or scenario option, the ability to use a specialty bay (such as sniper bay or heavy weapons bay), etc.
In at least one preferred embodiment of the present invention, a list, including the name and/or picture, and/or league or team affiliation) of current high scorers is displayed at the location and online. This includes options to display daily, weekly, monthly scores as well as all-time high scores for each game or scenario. One preferred embodiment is a list of the best teams (2 or more participants), their high scores, along with pictures of the team.
In at least one preferred embodiment of the present invention, the various function and features of the system for scoring and ranking shooters are used to create league competitions, including a team leaders and a list of people who are associated with a team as well as team stats, league stats, etc. with prizes and awards being presented to the best shooter, most improved shooter, best team, etc. at the end of league play or a tournament.
In at least one preferred embodiment of the present invention, shooting scenarios and game play are tailored to corporate events (e.g., company parties, team building exercises, etc.). For example, competition between the employees of two local businesses could compare their scores at a corporate event. This also applies to different employees or teams within the same company and may include scores on cooperative as well as competitive games or scenarios.
In at least one preferred embodiment of the present invention, two or more replica firearms could be selected for use by multiple shooters to permit head-to-head competition or cooperative games within the same bay.
In the most preferred embodiments of the present invention, only replica firearms are used at the facility and no live firearms are in use at the facility.
In at least one preferred embodiment of the present invention, shooters have the capability to zero their weapons at any time (e.g., at the start of the game, during a pause in game play during the game, or at the end of the game) and confirm their weapon is firing accurately before beginning another game. The software associated with the system should support the ability to stop the game play or scenario and zero a weapon, at any time during use, even though the shooter would have option to have them finish the current game before doing a weapon zero.
In at least one preferred embodiment of the present invention, simple weapon assignment is accomplished by using a color or number label system to identify the weapons. If using color, certain colors are avoided so as to provide for shooters afflicted with color blindness
In at least one preferred embodiment of the present invention, the shooter is presented with the option of selecting a tethered non-gun M240 or other heavy machine gun to be used in a special heavy machine bay.
In at least one preferred embodiment of the present invention, the shooter may select a weapon from a large variety of weapons and the game play options and shooting scenarios for the shooter will be automatically customized based on the selected weapon or weapons (e.g., if the shooter selects a scoped weapon, sniper game play and scenarios will be enabled).
In at least one preferred embodiment of the present invention, the replica firearms with laser activation could be tetherless or tethered, but look and feel much more like real firearms than the plastic guns common in arcade games.
In at least one preferred embodiment of the present invention, the shooter's time in a shooting bay is metered and time remaining is displayed in one or prominent locations within the shooting bay. Additionally, one or more audible signals may sound to indicate the impending expiration of the time period. If the shooter would like to stay in the shooting bay and extend their time period, they may opt to add more time to the current game or scenario. Alternatively, the system may suggest another game and display “thumbnail” images to indicate available options to encourage the shooter to stay in the shooting bay but select an alternative game or scenario. After each game restart or repeat, the system may be configured to suggest a different “next game” to the shooter. For example, after the shooter runs out of time on a game, the system could present three options: Restart, Suggested New Game (with image), or Main Menu.
In at least one preferred embodiment of the present invention, a user-configurable notification and privacy options are available so that shooters who want to receive alerts about shooting activities (e.g., new high score posted, friends or teammates participating in a competition) are notified via user-configurable options (e.g., email, SMS, etc.). Another option allows a shooter to block all notifications or receive a periodic (weekly, monthly, etc.) summary of updates and notifications. Shooters may also set their communication preference to receive or block notices of specials, leagues, competitions, etc. For at least one preferred embodiment of the present invention, a mobile device “app” is provided to allow a shooter to receive customized notifications on a smart phone, tablet, etc. For another preferred embodiment, an “app” is provided where the user can check on the latest updates such as league play, specials, new games coming soon, etc.
In at least one preferred embodiment of the present invention, the system allows the system operator an option to allow the user to activate another experience even if the user has some time left but not quite enough for another experience. This would generally apply to timed games.
In at least one preferred embodiment of the present invention, at the end of a game, there would be a quick bullet cam where a screen displays a zoom in on the bullet and follows the bullet (in real time or, based on user options, in slow motion) to the exact impact point on the target. The entire bullet cam sequence may be displayed for a user configurable amount of time (e.g., 1-10 seconds) and may be immediately cancelled by one or more shooters if they shoot at the screen or by a tap on the touch screen console in their shooting bay.
In at least one preferred embodiment of the present invention, a bullet cam implementation where the focus is on the best shot (e.g., the shot closest to the bull's-eye on the simulated target) that is achieved during the shooting experience for both shooters. In at least one preferred embodiment of the present invention, a split screen will show one user's bullet cam on half of the screen and another user's bullet cam on the other half of the screen—each showing in slow motion their most accurate shot during the game.
In at least one preferred embodiment of the present invention, includes an easy-to-use design-your-own game station where a user can create a game or scenario for use by the user or others on the simulators. Alternatively, the software could be available on personal computers or as an “app” so a user could prepare a game or game(s) without need of a design-your-own game station.
In at least one preferred embodiment of the present invention, the user's weapon's effect increases through a power-up that is earned during the game experience or based on rank.

### Additional Shooting Challenges and Game Versions for Alternative Preferred Embodiments:

In at least one preferred embodiment of the present invention, a prescribed course of shooting competition will be conducted in a simulated environment (e.g., International Defensive Pistol Association [“IDPA”] or National Rifle Association [“NRA”]) mimicking the live fire shooting competition experience.
In at least one preferred embodiment of the present invention, a quick draw game competition will pit the shooter against a computer generated image (“CGI”) character in a competition to shoot faster (and hit the target) than the on-screen character. Options would include drawing from the holster and may include a feedback option (e.g., mild electric shock or vibration) on the shooter so if they don't shoot fast enough, they feel a mild electric shock or a vibration. In this case, the feedback device is similar to the feedback device specified in one or more of the parent patent applications. At least one preferred embodiment may simulate a quick draw duel where the camera(s) shows two people in a bay and each shooter draws a simulated firearm and shoots at the screen. In this embodiment, both shooters face forward but the image of each shooter would be projected on the opponent's screen, allowing each shooter to watching the projected image in front of them.
In at least one preferred embodiment of the present invention, multiple webcams are added to the bay so that enhanced video can be taken, such as a “wild west” quick draw game where each participant sees a video of the other on the screen in front of them and attempts to draw and shoot faster than the other person while still hitting the mark. Another embodiment is to add a vibration or a shock device to one or more participants so if they get hit during the quick draw game, they immediately feel some level of vibration or electric shock notification and/or discomfort. The participants may need to wear a special T-Shirt (such as solid blue color) so that the system (with webcam) can automatically detect whether or not they are hit by the other person. The computer would compare the shot placement to the special T-Shirt area.
In at least one preferred embodiment of the present invention, each shooter is represented by the image of a mountain climber projected on the screen. Each shooter will shoot at the location on the “mountain” where they want the climber to climb. A graphical image projected on the screen (e.g., a white/black lined circle) shows the extent of the climber's reach. The point of the game is to get your climber to the top of the mountain before the opponent's climber reaches the top of the mountain. Alternatively, in a “best time” mode, a single player can strive to beat a score posted by a previous player. In this embodiment, if the simulated shot from the shooter is outside the circle defining the climber's reach, the climber doesn't advance, or may fall, requiring the shooter to start the ascent over again. Similarly, if the climber is accidentally shot, the climber will fall down. In another mode of play, the climber has no circle around them, instead each shooter will aim at the next handhold image depicted on the screen that the mountain climber should grab. Smaller holds may move the mountain climber a greater distance up the mountain. In a “head to head” climbing battle, only one mountain climber can use a given handhold so if the other player already has their mountain climber on a handhold, the second mountain climber can't use that handhold until the first climber has moved on. Another preferred embodiment is a cooperative game where multiple users work together to help the climber reach the top of the mountain as quickly as possible.
In at least one preferred embodiment of the present invention, a number of shooting gallery experiences are presented, each with a different theme. Some themes include: wild west town, a dinosaur park, a circus, an outer space, Rube Goldberg, and shooting practice. These experiences are based on hitting a target and with the shooter being rewarded with entertaining visuals and sounds along with points.
In at least one preferred embodiment of the present invention, various shooting challenges are presented to test the shooter's accuracy, and/or decision making skills and/or speed of hitting a target. Each of these variations are intended to form a baseline standard by which people can compare their skills with others.
In at least one preferred embodiment of the present invention, various shooting experiences designed just for fun, where the screen portrays images such as bottles on a fence, pop-up targets, etc. for the shooter to engage and hit. Special effects, like sparks off metal, or explosives are added for entertainment value and to provide feedback for the shooter.
In at least one preferred embodiment of the present invention, a simulated indoor and outdoor shooting range is presented with standard targets, similar to what police or military might use during their training. This option also includes various industry standard paper targets and/or pop-up targets.
In at least one preferred embodiment of the present invention, a shooting skill escalation program is available. As the shooter completes a series of shooting challenges, the shooter progress to the next level where each level is more difficult and presents more complicated shooting challenges. However, if the shooter makes a mistake, then various penalties may be incurred and the shooter may have to end that round and start over at the previous level. The key is to see how high of a level the shooter can obtain. In this embodiment, the shooter may be ranked on accuracy, for speed or for a required level of both speed and accuracy.
In at least one preferred embodiment of the present invention, gameplay includes a computer generated image, such as a ball or a wheel, where the shooter can slow down or speed up the object by accurately shooting at targets along the objects intended path.
In at least one preferred embodiment of the present invention, the gameplay includes a computer-generated image of an object, such as a car, racing towards a wall and the shooter must shoot the object before it hits the wall. The object of the game is to allow the object to get as close as possible to the wall, without actually touching or impacting the wall.
In at least one preferred embodiment of the present invention, a “core score” is generated for each user, based on their skill and ability in various measured tests. A “handicap” may also be established for competitive leagues and teams so as to allow less skilled shooters to compete with more highly skilled shooters. By examining a shooter's “core score” and “handicap” each shooter can be compared to all other shooters.
In at least one preferred embodiment of the present invention, a shooting game very similar to bowling would be presented. The user would shoot at the pins and a ball would roll at where the user shot. The game difficulty would be adjusted to where it is similar to the distribution curve of skills as compared to real bowling.
In at least one preferred embodiment of the present invention, a shooting game very similar to volleyball would be presented. The user would shoot at the volleyball before it hit the ground and the location of the shot would influence the direction of the volleyball. One version of the game would include teammates taking turns hitting the ball, just like with real volleyball.
In at least one preferred embodiment of the present invention, one user or team fires the gun to plant virtual man-eating flowers while the other user or team fires the gun to eliminate the dangerous plants. The plants march towards the screen and once they reach the screen the game is over.

In at least one preferred embodiment of the present invention, one user or team fires at a horde of cartoonish characters, with the right number of threats based on the number of weapons active. From the foregoing description, it should be appreciated that simulated firearm entertainment system disclosed herein presents significant benefits that would be apparent to one skilled in the art. Furthermore, while multiple embodiments have been presented in the foregoing description, it should be appreciated that a vast number of variations in the embodiments exist. Lastly, it should be appreciated that these embodiments are preferred exemplary embodiments only and are not intended to limit the scope, applicability, or configuration of the invention in any way. Rather, the foregoing detailed description provides those skilled in the art with a convenient road map for implementing a preferred exemplary embodiment of the invention, it being understood that various changes may be made in the function and arrangement of elements described in the exemplary preferred embodiment without departing from the spirit and scope of the invention as set forth in the appended claims.

1. A simulated firearms entertainment system comprising:
at least one shooting bay;
at least one screen located in the at least one shooting bay, the at least one screen displaying a plurality of graphic images to a first participant physically present in the at least one shooting bay;
a simulated firearm controlled by the first participant; and
a social interaction element related to the simulated firearm controlled by the first participant wherein the first participant interacts with and communicates with a second participant who is also physically present in the at least one shooting bay, the social interaction element comprising the first participant and the second participant engaging in at least one of: ad hoc conversation; meal sharing; and physical contact.

2. The simulated firearms entertainment system of claim 1 further comprising:
a plurality of participation options for a plurality of users in an entertainment venue located outside of a home environment;
a plurality of replica firearms controlled by the plurality of users; and
at least one of: an integrated leader board; at least one picture or video of the plurality of participants; and at least one social media interaction accomplished via Twitter, Facebook, or Instagram.

3. The firearm simulation system of claim 2 wherein the at least one of an integrated leader board, at least one picture or video of the plurality of participants, and at least one social media interaction comprises:
an integrated leader board;
at least one picture or video of the plurality of participants; and
at least one social media interaction.

4. The firearm simulation system of claim 2 further comprising a plurality of users wherein each of the plurality of users is assigned a rank based on one or more criteria including at least one of age, skill, accuracy, speed, and frequency of interaction with the simulated firearms entertainment system.

5. The firearm simulation system of claim 4 wherein the rank may be increased by at least one of: the expenditure of money; hours of interaction with the simulated firearms entertainment system; and proficiency with different replica firearms selected from the plurality of replica firearms.

6. The firearm simulation system of claim 4 wherein at least one of the plurality of users is awarded additional privileges and game play options based on achieving a certain rank.

7. The firearm simulation system of claim 6 wherein the additional privileges and game play options comprise at least one of:
a higher priority for making reservations at the entertainment venue;
a shorter waiting time to enter the entertainment venue;
early access to new games offered at the entertainment venue; and
a larger selection of replica firearms to choose from.

8. The firearm simulation system of claim 2 wherein the plurality of users are organized into a plurality of teams and wherein various forms of competition are provided at the entertainment venue.

9. The firearm simulation system of claim 8 wherein the plurality of teams are organized on the basis of pre-existing social groupings such as company, family, and friends.

10. The firearm simulation system of claim 3 wherein the user may select a simulated weapon from the plurality of replica firearms and game play options and scenarios for the user will be automatically customized based on the simulated weapon selected by the user.

11. The firearm simulation system of claim 3 wherein a camera can display a series of visual images to represent the user's movements.

12. A method of social interaction between a plurality of users comprising the steps of:
entering a firearms simulation bay with the plurality of users, wherein each of the plurality of users is physically present in the firearms simulation bay;
engaging in at least one simulated game using a plurality of replica firearms controlled by the plurality of users;
tracking and displaying a score for each of the plurality of participants where the score is based on at least one of:
accuracy;
speed; and
target selection; and
wherein the social interaction between the plurality of users comprises at least one of ad hoc conversation; meal sharing; and physical contact.

13. The method of claim 12 further comprising the step of zeroing at least one of the plurality of replica firearms.

14. The method of claim 12 further comprising the step of creating a leaderboard, the leaderboard showing a graphical image of at least one of the plurality of users with a score that is higher than any of the other users in the plurality of users.

15. A firearm simulation entertainment system for playing games comprising:
a first plurality of users physically present in a first entertainment venue located outside of a home environment, the first entertainment venue comprising at least one video screen;
a second plurality of users physically present in a second entertainment venue located outside of a home environment, the second entertainment venue comprising at least one video screen;
a plurality of graphical game images displayed to the first plurality of users and to the second plurality of users wherein the first plurality of users compete against the second plurality of users to obtain a high score based on interaction of the first and second plurality of users with the graphical game images; and
facilities for the first plurality of users and the second plurality of users to engage in ad hoc conversation, meal sharing, and physical contact.

16. The firearm simulation entertainment system of claim 18 further comprising a plurality of a laser-activated replica firearms wherein each of the first plurality of users and second plurality of users controls at least one of the laser-activated replica firearms and interacts with the plurality of graphical game images via the plurality of a laser-activated replica firearms.

17. The firearm simulation entertainment system of claim 18 wherein the first entertainment venue and the second entertainment venue are in close geographical proximity.

18. The firearm simulation entertainment system of claim 18 wherein the first entertainment venue and the second entertainment venue are geographically remote and are communicatively coupled via a computer network.
